(19) United States
(12) Patent Application Publication
(10) Pub. No.: US 2019/0392533 A1
(43) Pub. Date: Dec. 26, 2019

(54) SYSTEM AND METHOD FOR DETERMINING FAULT PATTERNS FROM SENSOR DATA IN PRODUCT VALIDATION AND MANUFACTURING PROCESSES

(71) Applicant: MTS CONSULTING & ENGINEERING GMBH, Fürstenfeldbruck (DE)

(72) Inventor: Frank THURNER, Fürstenfeldbruck (DE)

(21) Appl. No.: 16/561,772

(22) Filed: Sep. 5, 2019

Related U.S. Application Data
(63) Continuation of application No. PCT/EP2018/055473, filed on Mar. 6, 2018.

(30) Foreign Application Priority Data
Mar. 8, 2017 (DE) 10 2017 104 884.7

(51) Int. Cl. G06Q 50/04; G06Q 10/06

(52) U.S. Cl. CPC G06Q 50/04; G06Q 10/06395

(57) ABSTRACT

A method is provided for monitoring at least one process and for determining fault patterns of faults occurring in the at least one process, wherein a parameter table with characteristic fault patterns is generated for a number of partial processes of the at least one process, wherein the parameter table is generated on the basis of historical sensor data, wherein the historical sensor data describes a number of historical curves which have at least two dimensions and are respectively assigned to a partial process, and wherein the historical curves for each partial process comprise historical OK curves (okay) and historical NOK curves (not okay), wherein the historical NOK curves represent faulty partial processes.

### CROSS REFERENCE TO RELATED APPLICATIONS

This application is a continuation of International Application No. PCT/EP2018/055473, filed on Mar. 6, 2018, which takes priority from German Application No. 10 2017 104 884.7, filed on Mar. 8, 2017, the contents of each of which are incorporated by reference herein.

### TECHNICAL FIELD

The invention relates to a method for determining fault patterns of faults occurring in at least one process and for monitoring a process (a manufacturing process comprising at least one process step or a product validation process/a product validation), each based on 2- to n-dimensional sensor data. Furthermore, the invention relates to a system configured for carrying out the method according to the invention.

### BACKGROUND

In the manufacture of goods, such as vehicles, the quality of the goods and the production or manufacturing process can be increased if faults in the production or manufacturing process can be assigned to a specific fault cause. A production or manufacturing process here comprises the production, assembly and/or commissioning of individual components, such as establishing a screw connection between two components of a vehicle. The number of possible fault patterns can be immense depending on the good to be produced—in vehicles, it can be in the four- or five-digit range. All in all, a high number of faults may accumulate, which may well be in the range of a few hundred errors.

In practice, it is difficult not only to detect a specific fault or a fault pattern, but also to associate the fault with a fault cause. In most cases it is therefore not possible to improve the production or manufacturing process, that is, to design the production or manufacturing process or the product in a less fault-prone manner, or to achieve a production or manufacturing process which is virtually fault-free.

The difficulty of determining a fault cause is also compounded by the fact that certain faults can have different causes. Thus, a particular fault may have arisen in one case due to a first fault cause and in another case due to a second fault cause. The fault or fault code alone therefore usually provides only insufficient information to be able to determine a fault cause and to be able to clear such cause.

### SUMMARY

Therefore, it is an object of the invention at least to partially overcome the disadvantages mentioned above. In particular, it is an object of the invention to enable a precise detection and localization of fault patterns and fault causes in product validation and production or manufacturing processes and thus make high-quality products and virtually fault-free production or manufacturing processes possible. The invention is intended to provide a significant contribution to the zero-fault strategy in products and production or manufacturing processes.

At least one of the above objects is achieved by a method and a system according to the independent claims. Further features and details of the invention as well as advantageous refinements and further embodiments emerge from the respective dependent claims, the description and the drawing. Features and details, which are described in connection with the method according to the invention, apply also in connection with the system according to the invention and vice-versa, so that with respect to the disclosure of the individual aspects of the invention, reference can always be made reciprocally between them.

Accordingly, a method is provided for monitoring at least one process and for identifying fault patterns of faults occurring in the at least one process, wherein a parameter table with characteristic fault patterns is generated for a number of partial processes of the at least one process, wherein the parameter table is generated on the basis of historical sensor data, wherein the historical sensor data describe a number of historical curves which have at least two dimensions and are respectively assigned to a partial process, and wherein the historical curves for each partial process comprise historical OK curves (okay) and historical NOK curves (not okay), wherein the historical NOK curves represent faulty partial processes.

It is particularly advantageous here if
the at least one process includes a manufacturing process and a product validation process/a product validation, and
the partial processes comprise process steps of the manufacturing process and product validation steps of the product validation process/product validation, and
the historical curves comprise historical process curves and historical product validation curves, the historical OK curves comprise historical OK process curves and historical OK product validation curves, and the historical NOK curves comprise historical NOK process curves and historical NOK product validation curves, and
the faulty partial processes include faulty process steps and faulty products.

It is also advantageous if the generation of the parameter table for each partial process comprises:
selecting the historical NOK curves from the historical curves; and
for each selected historical NOK curve and depending on the type of partial process:
   dividing the historical NOK curve into a number of sections or into a number of quadrants;
   determining a number of parameter values for each section/each quadrant, the parameters relevant to the type of partial process being stored in a configuration table;
   performing a mapping step in which a fault pattern is assigned to the historical NOK curve, wherein the fault pattern is selected from a set of fault patterns relevant to the type of the partial process, which are stored in the configuration table, and wherein a fault pattern is preferably assigned to a plurality of historical NOK curves.

Generating the parameter table may, after assigning the fault patterns to the historical NOK curves, further comprise:
determining a characteristic distribution for each fault pattern for the parameters belonging to the respective fault pattern (parameter populations);
from all fault patterns, determining those fault patterns that are unambiguously identifiable on the basis of a single parameter population, wherein this one parameter population does not overlap with any other parameter population of the fault patterns; and
inserting the determined unambiguously identifiable fault patterns in the parameter table, wherein only those values of the parameter population with which the error image is unambiguously identifiable are stored as a feature in the parameter table for the respective fault pattern.

It is advantageous if the following steps are carried out for those fault patterns that are not unambiguously identifiable on the basis of a single parameter population:
i) reducing the interval lengths of the parameter populations by a predetermined relative or absolute value;
ii) determining those error images that are unambiguously identifiable based on a parameter population with reduced interval lengths and inserting the determined unambiguously identifiable fault pattern at the end of the parameter table, wherein the values of the parameter populations having the original interval lengths are stored as characteristics in the parameter table; and
iii) checking if there are still fault patterns that have not been inserted in the parameter table, and if this test is positive, continuing with step i) until all fault patterns have been inserted into the parameter table.

The features stored in the parameter table can be adjusted before storage by a predetermined relative or absolute value, in particular the interval limits can be increased by a predetermined relative value. This can compensate for fluctuations in the detection of fault patterns.

After inserting all fault patterns into the parameter table, a verification step may be performed, wherein the verification step comprises:
i) for each historical NOK curve on the basis of which the parameter table was generated, determining an associated fault pattern based on the parameter table by selecting that fault pattern whose characteristics in the parameter table match the characteristics of the historical NOK curve; wherein the fault patterns stored in the parameter table are compared in ascending order with the characteristics of the historical NOK curve and the comparison is terminated when a fault pattern has been determined;
ii) for each historical NOK curve from step i), verifying whether the detected fault pattern matches the fault pattern associated with the historical NOK curve in the mapping step; and
iii) if, for a fault pattern in step ii), a certain number of detected fault patterns do not match the associated fault patterns,
   saving the number to the fault pattern in the parameter table;
   generating at least one additional characteristic and storing the additional characteristic, together with the characteristics of the fault pattern as a new fault pattern in the parameter table; and
   performing the steps of claim 4 for those fault patterns which have at least one additional characteristic.

For fault patterns that are not unambiguously identifiable even with the additional characteristic, it is advantageous to perform a binary logistic regression, wherein for these fault patterns the formula of the binary logistic regression is stored to the fault pattern in the parameter table and then the verification step is repeated.

In the parameter table, those fault patterns can be marked for which the smallest respective number was stored in the verification step.

The historical sensor data may be provided by sensors. These sensors may be assigned to a production plant, a tool, a testing device and/or a product validation device.

After creating the parameter table, the following steps can be performed:
a) collecting sensor data provided by sensors during a partial process, wherein the collected sensor data describe at least one curve having at least two dimensions, and wherein the collected sensor data is assigned to the partial process;
b) comparing the collected sensor data with characteristic fault patterns for this partial process stored in the parameter table, wherein, for the comparison, actual characteristics are extracted from the collected sensor data corresponding to the characteristics that describe the characteristic fault patterns of this partial process, wherein the actual characteristics are compared with the characteristics in the parameter table according to a comparison rule; and
c) selecting that fault pattern from the parameter table, the characteristics of which match the actual characteristics to a predetermined degree of matching.

For the predetermined degree of matching, it is optionally provided that each actual characteristic and the corresponding characteristic of the fault pattern satisfy a predetermined matching criterion.

After step c), at least one fault cause associated with the fault pattern and/or at least one fault elimination measure associated with the fault pattern can be selected for the selected fault pattern, wherein the fault causes and/or the fault elimination measures and the assignment to the respective fault pattern are stored in a table.

Further provided is a system which is adapted to carry out a method according to the invention, in particular a computer system with a memory device in which the parameter table is stored and an interface for accepting sensor data in which fault patterns are to be detected.

### BRIEF DESCRIPTION OF THE DRAWINGS

Further details and features of the invention will become apparent from the following description taken in conjunction with the drawings, wherein the invention is not limited to the embodiments described below. In the figures:

FIG. 1 shows a flowchart of a method according to the invention

FIG. 2 comprises a set of process curves comprising a number of historical NOK process curves and a number of historical OK process curves;

FIG. 3 shows a specific example of a historical OK process curve and a historical NOK process curve (divided into quadrants); and

FIG. 4 shows an exemplary distribution of the values of a parameter for a plurality of fault patterns.

### DETAILED DESCRIPTION

With a method according to the invention or with a system according to the invention, it is possible to achieve virtually fault-free and robust products and processes, in particular manufacturing processes. The method and the system make a significant contribution to the zero-fault strategy and to product and process optimization by means of digital networking of the processes in production and assembly.

Exemplary applications of the method according to the invention are
distinguishing between OK cases (okay) and NOK cases (not okay), such as distinguishing between faulty and non-faulty products, or between faulty and non-faulty processes, based on process and/or product validation curves or based on continuous characteristics, such as Online during a manufacturing process, and/or
recognizing fault patterns from NOK curves, for example from NOK process and/or product validation curves, to be able to initiate specific troubleshooting measures on the basis of the fault patterns.

With the method/system described herein, fault patterns from product validation and process curves can thus be identified, causal relationships and causes for each fault pattern can be determined, and solutions and measures for each fault cause can be offered or made available. If the fault patterns are detected directly during a production process, for example, measures for eliminating the faults can already be initiated and carried out in the production process.

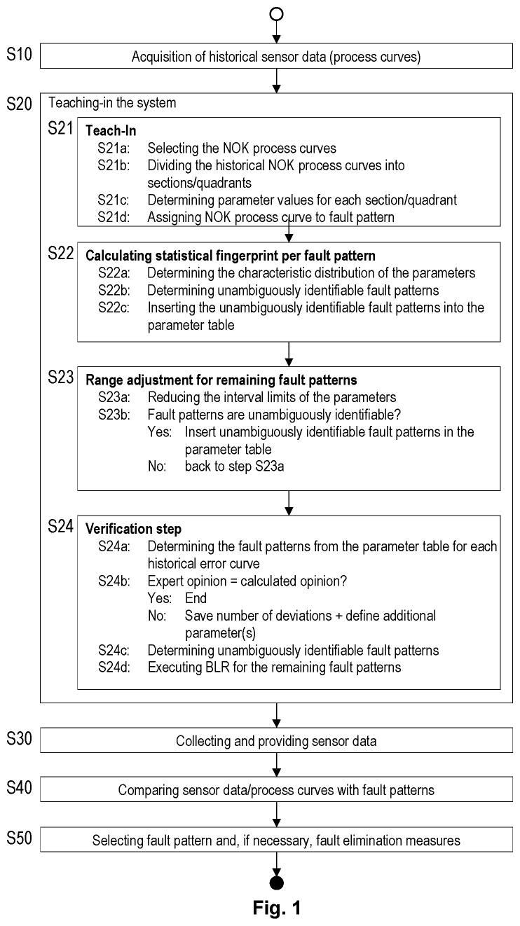

FIG. 1 shows a flowchart of a method according to the invention.

It is provided that a system with which a monitoring of product validation and/or process steps of a manufacturing process is to be carried out or with which the fault patterns of defective products and/or process steps are to be identified must first be “taught in”. On the basis of the “learned” information, the system can then monitor the product quality or product functionality and/or a manufacturing process and identify faulty products and/or process steps and their possible causes, preferably online, i.e., for example, during the product validation and/or manufacturing process, and suggest solutions and measures for the elimination of faults based on the determined fault patterns.

Hereinafter, the term “process step” includes both product validation steps and/or process steps of a manufacturing process. These process steps are also called partial processes. The term “manufacturing process” also comprises product validation processes. The term “process curves” also comprises product validation curves.

The method described below with reference to processes, process steps and process curves can therefore also be applied to product validations, product validation processes or product validation curves.

For this purpose, in a first step S10, the detection of sensor data is provided, on the basis of which the “teaching-in” of the system is carried out in a further step S20. The sensor data can describe process curves of a specific process or process step, i.e. the sensor data are preferably acquired as n-tuples (n>=1).

The sensor data are provided by sensors which monitor, for example, a specific production device or a specific tool. For example, an electric torque driver may have a torque sensor and an angle sensor with which the torque and the angle of rotation can be detected during a screwing operation. From the recorded torques and angles of rotation (2-tuple), a process curve can be generated which indicates the torque as a function of the angle of rotation.

Sensors for further physical parameters may be provided. Thus, for example, a timer may be provided which, in addition to the torque and the rotation angle, also detects the screwing times (e.g. in milliseconds). From the recorded torques, angles of rotation and screwing times (3-tuple), a process curve (in this case a three-dimensional process curve) can again be generated which indicates, for example, the torque as a function of the angle of rotation or the torque as a function of the screwing time.

Instead of curves, it is also possible to provide continuous features for a process and/or product validation.

This sensor data acquired for teaching-in the system or the process curves derived therefrom are referred to below as “historical sensor data” or “historical process curves”. The historical sensor data is stored in a memory device of the system. Depending on the nature of the process, the historical sensor data or the historical process curves can be collected over a certain period of time in order to provide a sufficiently large database for learning.

If historical sensor data for different processes or process steps is collected, the historical sensor data is assigned to the respective process or process step in the memory device. In order to be able to recognize faulty process steps during monitoring, it is advantageous if the historical process curves belonging to a process or process step comprise not only OK process curves but also a minimum number (for example, at least six) of NOK process curves. The NOK process curves represent faulty process steps or faulty products or product functions.

The following steps S21 to S24 are performed in the course of step S20 or are substeps of step S20.

The steps S21a to S21d are referred to as “Teach-in” S21.

Steps S22a to S22c are referred to as “Fingerprint calculation” S22.

Steps S23a to S23b are referred to as “Range adjustment” S23.

Steps S24a to S24d are referred to as “Verification step” S24.

First, a parameter table is generated and stored in the memory device of the system. After teaching-in the system, the parameter table contains a number of characteristic fault patterns for a number of different processes or process steps.

For this purpose, first, in a step S21a, the NOK process curves from the corresponding historical process curves (which have NOK and OK process curves) are selected for each process to be taught-in.

The selection of the NOK process curves can be made by a user, for example by means of an appropriate input/selection screen. In this case, the number of selected NOK process curves should reach a certain order of magnitude to ensure that there is a certain sample size of NOK cases for each “fault pattern” to be “taught-in”.

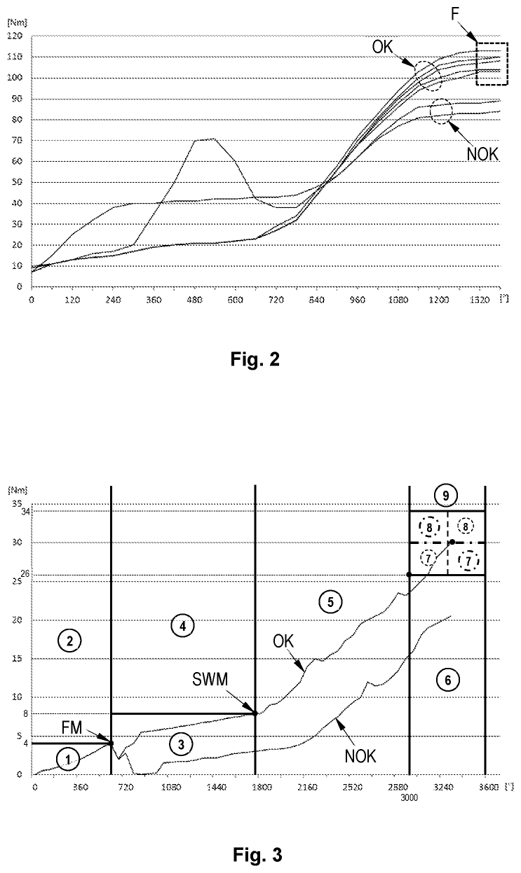

An example of a set of historical process curves, including a number of NOK process curves and a number of OK process curves, is shown in FIG. 2. The torque curves are shown here as a function of the angle of rotation in a screwing operation. The NOK process curves here are those curves that end outside of a predetermined target range, wherein the target range is represented here by the window F. The window F is defined here by a specific rotation angle interval and by a specific torque interval.

Following the selection of the historical NOK process curves, these are divided into sections or quadrants (individually or together) in step S21b. A historical NOK process curve divided into quadrants is shown in FIG. 3, where a historical OK process curve is also shown. In the example shown in FIG. 3, the NOK process curve is divided into a total of 9 quadrants.

The division of the historical NOK process curves into quadrants or sections can be done in two ways:
1. Based on various setting parameters of the tools or machines whose sensors generate and provide the sensor data for the respective historical process curve, the sections or quadrants can be set automatically. In a screwing operation, for example, the finding torque, the threshold torque, the desired torque, further torques, and the respective angles or angles of rotation may be used for this purpose. For example, in the example shown in FIG. 3, the finding torque FM and the threshold torque SWM and the respective angles of rotation have been used as parameters for setting the first four quadrants.
2. Based on input from a user. In this case, the user can set the sections or quadrants themselves, taking into account certain parameters or even independently of the parameters.

After dividing the historical NOK process curves into sections/quadrants, a number of parameter values are determined in a next step S21c for each section/each quadrant of each NOK process curve. The parameters for which the values are to be determined depend on the one hand on the type of process step on which the respective NOK process curve is based and on the other hand on the respective section/quadrant. For example, different parameters may be provided for two different screwing processes or for two different quadrants of a NOK process curve whose values are to be determined.

The parameters relevant for each type of process step and for each section/each quadrant are stored in a configuration table which may be stored in the memory device of the system. The parameters may comprise statistical parameters. Examples of such parameters per section/quadrant are:
End value (X), end value (Y)
Max (X), Max (Y)
Standard deviation (X), standard deviation (Y)
Mean/Median (X), Mean/Median (Y)
Slope Y (at X from; to), curvature Y (at X from; to), etc.

Depending on the type of NOK process curve and section/quadrant, certain parameter combinations can be defined.

The determined parameter values can be stored in the memory device and assigned to the respective historical NOK process curve.

After the parameter values have been determined for the historical NOK process curves, fault patterns are assigned to the historical NOK process curves in a mapping step S21d. Preferably, each historical NOK process curve is individually assigned a fault pattern. This is preferably done manually. To assist the user, the respective historical NOK process curve can be visualized, with preferably the quadrant/section division and the ascertained parameter values also being displayed. In addition, those historical NOK process curves assigned the same fault pattern can be shown.

Depending on the type of historical NOK process curve, different fault patterns can be assigned. The possible assignable fault patterns are stored in a configuration table. For example, the fault pattern “Rotation angle too large” can be assigned to a NOK process curve, which represents a screwing operation, but not a NOK process curve, which represents a soldering operation. Of course, a particular fault pattern can be assigned to several NOK process curves of different processes or multiple NOK process curves of the same process.

The assignment of a NOK process curve to a fault pattern is stored in the memory device of the system. With that, every fault pattern is simultaneously assigned a number of parameters.

Fault patterns for a screwing operation (e.g. with an electric torque screwdriver) may be for example:
Slippage/spinning of the screwdriver
End angle too high
End torque etc. too low

The historical NOK process curve shown in FIG. 3 can be assigned, for example, the fault pattern “slippage”, which can be recognized, for example, by the torque suddenly dropping to almost 0 Nm at an angle of rotation of approximately 720°.

After mapping the fault patterns to the historical NOK process curves, it can be checked for each assigned fault pattern whether the number of historical NOK process curves meets the criterion of a representative sample size. For example, it can be checked whether a fault pattern has been assigned to at least n (e.g. n≥6) historical NOK process curves.

After step S21d and, if necessary, the sample size check, a number of historical NOK process curves with associated fault patterns and a representative sample size per fault pattern are stored in the system. The “teach-in” is thus completed. The assignment of a fault pattern to a historical NOK process curve is referred to below as “expert opinion”.

Next, in step S22, a so-called statistical fingerprint is calculated for each fault pattern, i.e. for the historical NOK process curves associated with a fault pattern.

For this purpose, first, in a step S22a, a characteristic distribution of the parameter values determined in step S21c of the historical NOK process curves assigned to the respective fault pattern is determined for each fault pattern. The historical NOK process curves associated with a fault pattern are referred to as fault pattern populations, each parameter of a fault pattern population (called parameter population) having a characteristic distribution.

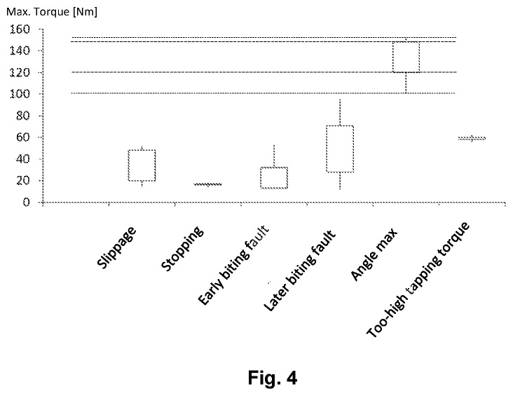

An example of the characteristic distribution in the form of box plots for the parameter “Max. torque” and for the fault patterns “Slippage”, “Stopping”, “Early biting error, “Late biting error”, “Angle max.” and “Tapping torque too high” is shown in FIG. 4.

Subsequent to step S22a, in a step S22b those fault patterns are determined which are unambiguously identifiable on the basis of a single parameter or a single parameter population. These are those fault patterns that have at least one parameter population that does not overlap with any other parameter population of the same parameter of all fault patterns. That is, a fault pattern having a parameter whose population does not overlap with the populations of the same parameter of other fault patterns is unambiguously identifiable with respect to that parameter. So that this fault pattern is also unambiguously identifiable with respect to this parameter, this parameter must not also unambiguously describe another fault pattern.

In the example shown in FIG. 4, the fault pattern “Angle max.” is unambiguously identifiable by the parameter “Max. torque” because the population of the parameter “Max. torque” of the fault pattern “Angle max.” does not overlap with any other population of the parameter “Max. torque” of the remaining fault pattern, while the populations of the parameter “Max. torque” overlap in the remaining fault patterns. For the remaining fault patterns shown in FIG. 4, it is then further checked whether there are other parameters with which the fault patterns are unambiguously identifiable on the basis of a single parameter.

The unambiguously identifiable fault patterns determined in step S22b are then sorted to the beginning of the parameter table in the subsequent step S22c. Here, preferably only values (e.g. interval limits) of the parameter in the parameter table are stored for each fault pattern and assigned to the fault pattern with which the respective fault pattern can be unambiguously identified. In the example shown in FIG. 4, for the fault pattern “Angle max.” only the values of the parameter “Max. torque” would be stored, such as in the form “100<=max. Torque [Nm]<=152”, if the lower and upper viskers (population limits) are stored as interval limits.

Thus, when monitoring a manufacturing process for a screwing operation, the fault pattern “Angle max.” may be determined when the maximum torque is between 100 Nm and 152 Nm.

In addition, the values of the remaining parameters can also be stored in the fault pattern in the parameter table, in which case the feature which makes it possible to unambiguously identify the fault pattern is separately distinguished.

The parameter values stored in the parameter table can be adjusted, for example, by a relative or absolute value. For example, interval limits can be adjusted by ±5%, so that in the above example “95<=maximum torque [Nm]<=159.6” would be stored. This can be used to compensate for fluctuations that were not recorded due to the sample size of the fault pattern population.

The following table shows a section of the parameter table for the fault pattern “Angle max” shown in FIG. 4, wherein the interval limits have already been adapted.

Because the parameter “Maximum torque [Nm]” makes the unambiguous identifiability of the fault pattern “Angle max.” possible, only these values are stored in the parameter table. The values of the remaining parameters remain empty.

| Parameter | Min. value | Max. value |
|---|---|---|
| Angle [°] | — | — |
| Standard deviation | — | — |
| Max. torque [Nm] | 95 | 159.6 |
| Initial torque [Nm] | — | — |
| Final torque [Nm] | — | — |

If several parameters are necessary for the unambiguous identifiability of a fault pattern, the corresponding values are stored in the parameter table for each of these several parameters. In addition, it can be stored in the parameter table how the values of the individual parameters are to be logically linked (AND/OR, XOR, . . . ).

Those (remaining) fault patterns which are not identifiable by means of a single parameter or by means of a single parameter population are post-processed in a subsequent step S23, which is called “range adaptation”, in order, if possible, to attain unambiguous identifiability for these fault patterns as well.

In this case, in step S23a, the interval lengths (e.g. the lower and upper viskers (population limits)) of all parameters of the remaining fault patterns are first reduced by a predetermined relative or absolute value.

Subsequently, it is checked in a step S23b whether there are now one (or several) fault patterns among the remaining fault patterns which are unambiguously identifiable on the basis of a single parameter.
If yes: The one or more unambiguously identifiable fault pattern(s) is/are inserted analogously to step 22c at the end of the parameter table, if necessary, with adapted interval limits of the parameters.
If no: Continue with the “range adjustment” by returning to step 23a.

The range adaptation is carried out iteratively until all fault patterns are unambiguously identifiable on the basis of a single parameter and inserted into the parameter table.

Upon completion of step S23, all fault patterns or parameters associated with these fault patterns are stored to the historical NOK process curves selected in step S21a in the parameter table as characteristics of the fault patterns.

Subsequent to step S23, a verification step S24 is performed.

According to a variant of the invention, the verification step is carried out only for those fault pattern which could only be sorted into the parameter table with the aid of step 23 (range adaptation).

According to a further variant of the invention, the verification step is carried out for all fault patterns.

Within the scope of the verification step S24, the associated fault pattern from the parameter table is first determined in step S24a on the basis of the previously generated parameter table for each historical NOK process curve (possibly with the aforementioned restriction) which was used to generate the parameter table. The fault pattern thus determined for a historical NOK process step is called “Calculated opinion”.

Subsequently, in a step S24b, it is checked for each historical NOK fault pattern whether the expert opinion corresponds to the calculated opinion or whether there are differences between the two opinions. Thus, it is checked whether the fault pattern associated with a historical NOK process curve in step S21d is identical to the fault pattern obtained for this historical NOK process curve in step S24a. Ideally, for each historical NOK process curve, the fault pattern associated with step S21d is identical to the respective fault pattern determined in step S24a.

The verification in step S24b is performed per fault pattern. That is, it is determined which NOK process curves have been assigned the fault pattern to be verified in step S21d. Subsequently, it is checked which fault patterns were determined for these historical NOK process curves in step S24a. If there are no deviations here, step S24 for this historical fault pattern can be terminated.

However, if deviations arise here for a fault pattern, i.e. if a different fault pattern was assigned to a historical NOK process curve in step S24a than in step S21d, the expert opinion deviates from the calculated opinion. The number of deviations can then be stored in the parameter table for the respective fault pattern. At the same time, one or more additional parameters are defined for this fault pattern. This fault pattern (original parameters and additional parameters) is then saved as a new fault pattern in the parameter table, wherein the fault pattern already existing in the parameter table can also be overwritten. The definition of the additional parameter(s) may be made by the user of the system. The additional parameters may be, for example, the distribution in an interval, the slope in an interval, the curvature in an interval, etc.

Subsequently, for those fault patterns for which additional parameters have been defined (step S24c), it is checked whether there are fault patterns that are unambiguously identifiable with a single parameter. For those fault patterns for which this is the case, the verification step ends here.

For the remaining fault patterns, a binary logistic regression (BLR) is carried out in a subsequent step S24d and the formula for the binary logistic regression is stored for the respective fault pattern.

In the parameter table, it is additionally stored for each fault pattern with which method the fault pattern was inserted into the parameter table, namely
according to steps S22b and S22c, or
according to the step S23b (range adjustment), or
according to step S24c (range adjustment+additional characteristics), or
according to step S24d (BLR),
wherein it is also indicated which method led to the least deviation between expert opinion and calculated opinion.

At the end of the step S24d, the step S20 also ends and the system can be regarded as being taught-in.

With the system taught-in for certain processes or process steps, these processes or process steps can be monitored online, i.e. during operation and preferably in real time, and immediately after detection of a fault, the employee can be notified of corresponding fault patterns and, if necessary, also appropriate fault elimination measures.

For this purpose, in a step S30 sensor data is provided by a tool/machine or the like, which is collected by sensors that are assigned to the tool/machine. For example, an electric torque driver may be associated with a torque sensor and an angle sensor. The sensor data in this case describes a process curve assigned to the process/process step, for example the course of the torque over time or the course of the torque over the rotation angle, for example during a screwing operation.

The sensor data thus obtained, or the resulting process curves, can now be compared in step S40 with the fault patterns stored in the parameter table. According to the parameters of the characteristic fault patterns associated with the process/process step, the corresponding parameter values are extracted from the respective process curve and compared with the parameters of the fault patterns in the parameter table.

If the comparison is positive, the corresponding fault pattern is selected from the parameter table as the result of the comparison in a step S50 and can then be made available to the user. In addition, fault elimination measures assigned to this fault pattern can be selected from an action table and also made available to the user.

Otherwise there is no fault, or the fault is still unknown. In the latter case, the system can be taught-in for this unknown fault, provided that a sufficiently large sample of corresponding historical NOK process curves is available.

This makes it possible, for example, to detect faults or fault patterns almost in real time in an ongoing production process. Sensor data provided in real time by, for example, a manufacturing plant can be directly compared with the stored fault patterns. In certain cases, a faulty process step can already be detected before the end of the process step—for example, a possible fault can be detected from the course of the torque of a torque wrench before the completion of the screwing operation, so that the screwing operation does not even have to be completed.

What is claimed is:

1. A method for monitoring at least one process and for determining fault patterns of faults occurring in the at least one process, wherein a parameter table with characteristic fault patterns is generated for a number of partial processes of the at least one process, wherein the parameter table is generated on the basis of historical sensor data, wherein the historical sensor data describe a number of historical curves which have at least two dimensions and are respectively assigned to a partial process, and wherein the historical curves for each partial process comprise historical OK curves (okay) and historical NOK (not OK) curves, wherein the historical NOK curves represent faulty partial processes.

2. The method of claim 1, wherein
the at least one process includes a manufacturing process and a product validation process/a product validation, and
the partial processes comprise process steps of the manufacturing process and product validation steps of the product validation process/product validation, and
the historical curves comprise historical process curves and historical product validation curves, the historical OK curves comprise historical OK process curves and historical OK product validation curves, and the historical NOK curves comprise historical NOK process curves and historical NOK product validation curves, and
the faulty partial processes include faulty process steps and faulty products.

3. The method of claim 1, wherein generating the parameter table for each partial process comprises:
selecting (S21a) the historical NOK curves from the historical curves; and
for each selected historical NOK curve and depending on the type of partial process:
dividing (S21b) the historical NOK curve into a number of sections or into a number of quadrants;
determining (S21c) a number of parameter values for each section/each quadrant, wherein the parameters relevant to the type of partial process are stored in a configuration table;
performing (S21d) a mapping step in which a fault pattern is assigned to the historical NOK curve, the fault pattern being selected from a set of fault patterns relevant to the type of the partial process stored in the configuration table, and wherein a fault pattern preferably is assigned to several historical NOK curves.

4. The method of claim 3, wherein generating the parameter table after assigning the fault patterns to the historical NOK curves further comprises:
for each fault pattern, determining (S22a) a characteristic distribution for the parameters (parameter populations) belonging to the respective fault pattern;
from all fault patterns, determining (S22b) those fault patterns that are unambiguously identifiable from a single parameter population, wherein this one parameter population does not overlap with any other parameter population of the fault patterns; and
inserting (22c) the determined unambiguously identifiable fault patterns in the parameter table, wherein only those values of the parameter population with which the fault pattern is unambiguously identifiable are stored for the respective fault pattern as a characteristic in the parameter table.

5. The method of claim 4, wherein for those fault patterns that are not unambiguously identifiable from a single parameter population, the following steps are performed:
i) reducing (S23a) the interval lengths of the parameter populations by a predetermined relative or absolute value;
ii) determining (S23b) those fault patterns that are unambiguously identifiable from a parameter population having reduced interval lengths and inserting the determined unambiguously identifiable error images at the end of the parameter table, wherein the values of the parameter populations having the original interval lengths being characteristics are stored in the parameter table; and
iii) checking if there are still fault patterns that have not been inserted in the parameter table, and if this test is positive, continuing with step i) until all fault patterns have been inserted into the parameter table.

6. The method of claim 4, wherein the characteristics stored in the parameter table are adjusted before storage by a predetermined relative or absolute value, in particular the interval limits are increased by a predetermined relative value.

7. The method of claim 6, wherein after inserting all the fault patterns in the parameter table, a verification step (S24) is performed, the verification step comprising:
i) for each historical NOK curve on the basis of which the parameter table was generated, determining (S24a) an associated fault pattern based on the parameter table by selecting that fault pattern whose characteristics in the parameter table match the characteristics of the historical NOK curve, wherein the fault patterns stored in the parameter table are compared in ascending order with the characteristics of the historical NOK curve and the comparison is terminated once a fault pattern has been determined;
ii) for each historical NOK curve from step i), verifying (S24b) whether the detected fault pattern matches the fault pattern associated with the historical NOK curve in the mapping step; and
iii) if, for a fault pattern in step ii), a certain number of detected fault patterns do not match the associated fault patterns,
saving the number to the fault pattern in the parameter table;
generating at least one additional characteristic and storing the additional characteristic, together with the characteristics of the fault pattern as a new fault pattern in the parameter table; and
for those fault patterns which have at least one additional characteristic:
determining a characteristic distribution for the parameters (parameter populations) belonging to the respective fault pattern;
from all fault patterns, determining those fault patterns that are unambiguously identifiable from a single parameter population, wherein this one parameter population does not overlap with any other parameter population of the fault patterns; and
inserting the determined unambiguously identifiable fault patterns in the parameter table, wherein only those values of the parameter population with which the fault pattern is unambiguously identifiable are stored for the respective fault pattern as a characteristic in the parameter table.

8. The method of claim 7, wherein a binary logistic regression is performed for fault patterns that are not unambiguously identifiable with the additional characteristic, and wherein for these fault patterns the formula of the binary logistic regression is stored to the fault pattern in the parameter table and the verification step is subsequently repeated.

9. The method of claim 8, wherein in the parameter table, those fault patterns are marked for which the smallest respective number was stored in the verification step.

10. The method of claim 1, wherein the historical sensor data is provided by sensors.

11. The method of claim 1, wherein after generating the parameter table, the following steps are performed:
a) collecting (S30) sensor data provided by sensors during a partial process, wherein the collected sensor data describe at least one curve having at least two dimensions, and wherein the collected sensor data is assigned to the partial process;
b) comparing (S40) the collected sensor data with characteristic fault patterns for this partial process stored in the parameter table, wherein for the comparison, actual characteristics are extracted from the collected sensor data corresponding to the characteristics that describe the characteristic fault patterns of this partial process, wherein the actual characteristics are compared with the characteristics in the parameter table according to a comparison rule; and
c) selecting (S50) that fault pattern from the parameter table, the characteristics of which match the actual features to a predetermined degree.

12. The method of claim 11, wherein at the predetermined degree of matching, each actual characteristic and the corresponding characteristic of the fault pattern satisfy a predetermined matching criterion.

13. The method of claim 11, wherein after step c), at least one fault cause associated with the fault pattern and/or at least one fault elimination measure associated with the fault pattern are selected for the selected fault pattern, wherein the fault causes and/or the fault elimination measures and the assignment to the respective fault pattern are stored in a table.
